(19) United States
(12) Patent Application Publication
(10) Pub. No.: US 2018/0198640 A1
(43) Pub. Date: Jul. 12, 2018

(54) METHOD AND SYSTEM FOR RAPID CHANGE OF ELECTRICAL RECEPTACLE AND CREATION OF SMART-READY ENVIRONMENT

(71) Applicants: Allen Nejah, San Jose, CA (US); Olatunbosun Abiodun Adebanjo, Richmond, TX (US)

(72) Inventors: Allen Nejah, San Jose, CA (US); Olatunbosun Abiodun Adebanjo, Richmond, TX (US)

(21) Appl. No.: 15/405,294

(22) Filed: Jan. 12, 2017

(51) Int. Cl. H04L 12/28; H02G 3/18; H02G 3/08; H01R 33/945; H01R 43/26

(52) U.S. Cl. CPC H04L 12/2827; H02G 3/18; H04L 2012/2841; H01R 33/945; H01R 43/26; H02G 3/081

(57) ABSTRACT

The present invention proposes a system and method for creating a hub for monitoring and controlling electrically driven devices within an existing structure, such as a residence or an office, whereby the system and method rely upon existing gang boxes and wiring present in the existing structure. Through the present invention, older structures will be able to gain the benefit of a hub environment without requiring new wiring, wherein the various electrically driven devices can be monitored and controlled.

### BACKGROUND

Mains electricity refers to general-purpose alternating current electric power supply, often found in residential property and office buildings. Mains electricity is often the form of electrical power consumers use when they connect, i.e., plug in, a variety of appliances, such as irons, coffee machines, hair dryers, etc.

Early wiring in homes and offices involved conductors that were bare or covered with cloth. This type of early wiring continued in homes and offices through to the mid-20^{th} Century. While the early wiring systems are not as safe as current day systems, many early wiring systems are still in use today.

The internet-networking of devices, tools, and appliances in residential homes and offices is a major innovative stage of residential development. Known Internet of Things IoT, as wireless hub, internet-networking serves to give consumers and users more monitoring and controlling of resources, such as the use of electricity, by providing data of electrical usage in real-time and historical usage and providing monitoring and controlling of electrically driven device.

Creating a residence that is networking ready is significantly difficult for older homes. This is because, under present industry practice, creating an networking ready residence requires replacing the electrical wiring within the residence, such that it can accept networking technology. With a significant number of homes in the United States aged from 39 to 45 years old, these older homes represent a hindrance to the spread of internet-networking technology throughout the U.S., and thus the ability at a country-level to make the use of electricity more efficient. It should be noted that the more efficient use of electricity is an environmental issue as better efficiency will require less generation of electricity.

The present invention relates to a system and method of creating a smart residence and office space, whereby the smart residence and office space can be created using existing electrical wiring.

It is an object of the present system to overcome these and other disadvantages in the prior art.

### DESCRIPTION

The present invention proposes a system and method for creating a hub for monitoring and controlling electrically driven devices within an existing structure, such as a residence or an office, whereby the system and method rely upon existing gang boxes and wiring present in the existing structure. Through the present invention, older structures will be able to gain the benefit of a hub environment without requiring new wiring, wherein the electrical supply for various electrically driven devices can be monitored and controlled.

The present invention, through the inclusion of different receptacles, can establish a wireless environment for monitoring and controlling appliances, an environment for narrowband applications, an environment for sensing different variables in a environment and surrounding such as temperature, lighting, etc. and any other specific applications created by the specific receptacle. In one embodiment, the receptacles can possess two or more of the specialized applications. The receptacles can function and perform the application through the inclusion of Integrated Circuits within the receptacles.

The present invention also proposes a system and method for rapid change of a receptacle, whereby following insert of the system into a pre-existing structure, changing receptacles and switches merely operates as a “plug and play” method.

This will allow a user to quickly insert a receptacle in the place of a switch if a receptacle is needed for an electrically driven device. In one embodiment, a specific receptacle having specific sensors can be inserted in order to gain a specific application, for example inserting receptacle in a room to measure room temperature or monitoring the light.

It should be expressly understood that the drawings are included for illustrative purposes and do not represent the scope of the present system. In the accompanying drawings, like reference numbers in different drawings may designate similar elements

As used herein, the term “electrically driven device” refers to a device requiring an alternating current mains source in order to operate. Examples of such electrically driven devices include lights, smart electronic devices and appliances.

The term “appliance” refers to microwave ovens, toasters, humidifiers, coffee makers, consumer electronics, computers, smart devices and other devices that require electrical AC current for operation.

The term “gang box” refers to a box which houses installed electrical componentry.

The term “wireless hub” refers to the internetworking of physical devices, including electrically driven devices and wireless devices, to allow the monitoring and controlling of such devices from remotely or wirelessly.

The term “receptacle” refers to switches, plugs, timers, wireless Integrated circuits, Sensors integrated circuit, and other such outlets or any other such type devices which connects to mains electrical supply to provide current.

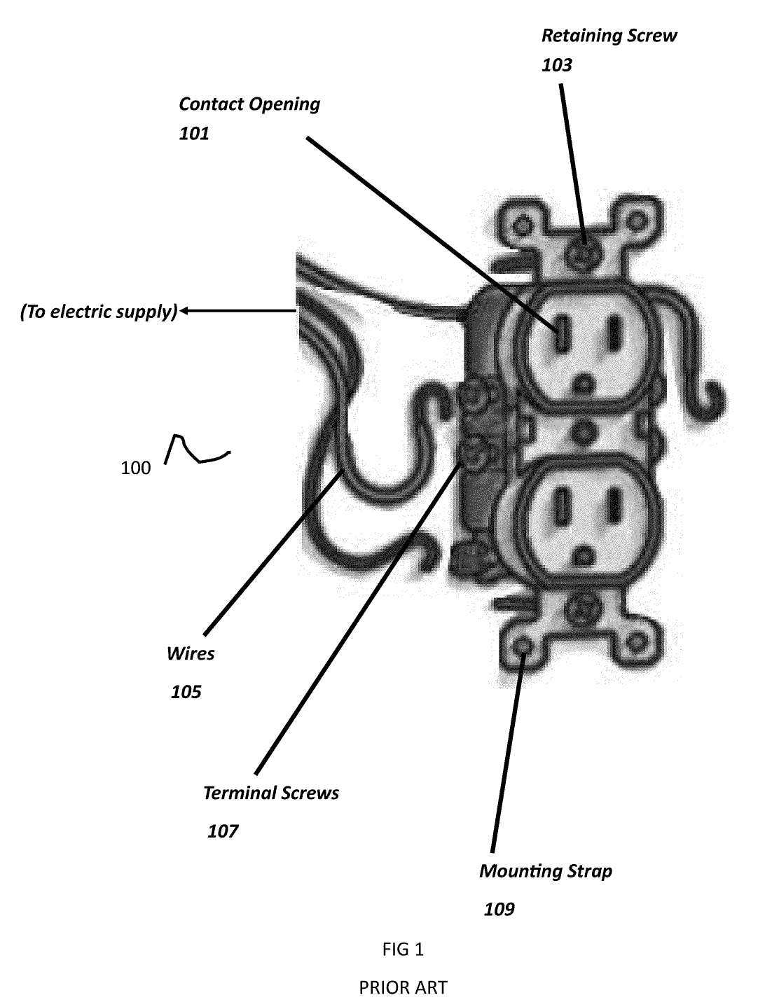

FIG. 1 shows the current state of the art relating to receptacle replacement.

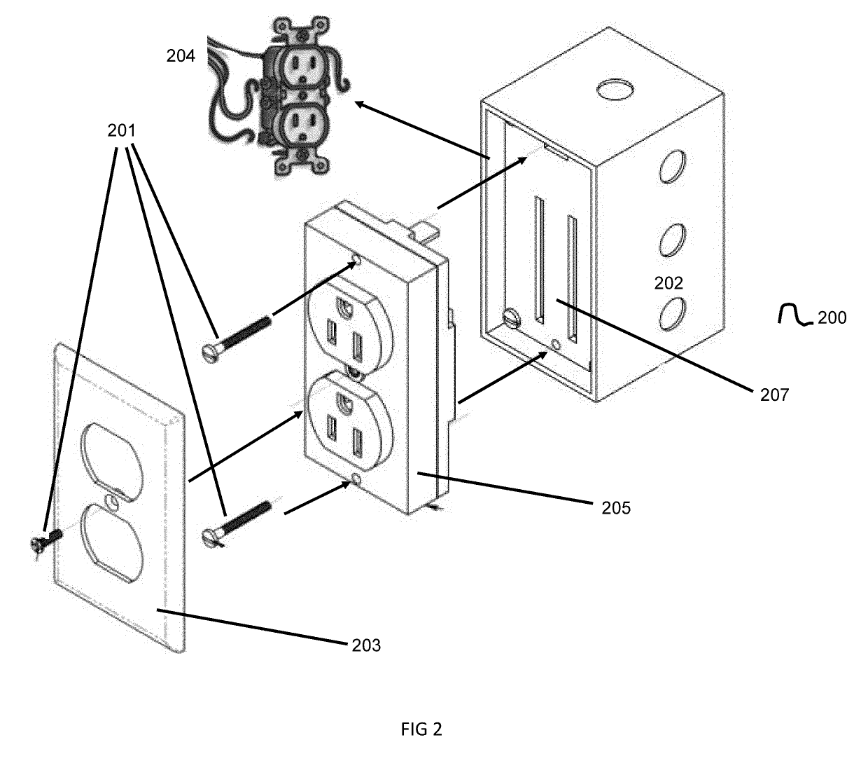

FIG. 2 is an embodiment of the system of the present invention.

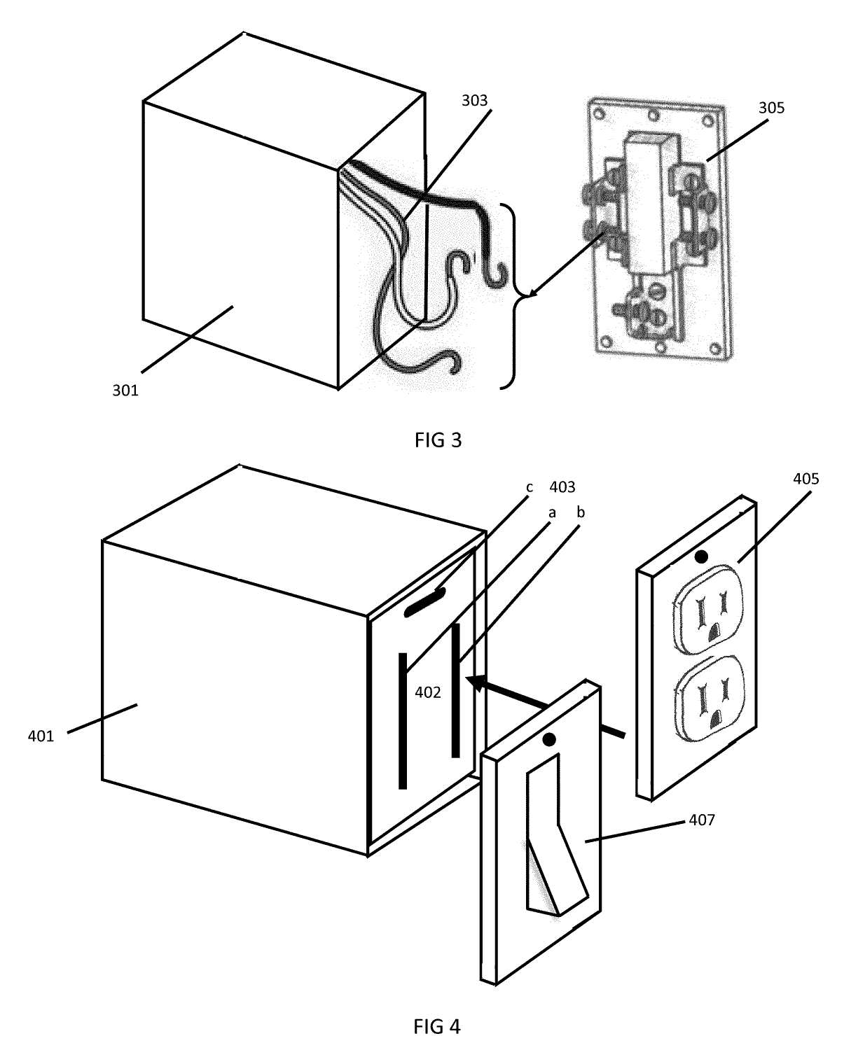

FIG. 3 is an aspect of the system of the present invention.

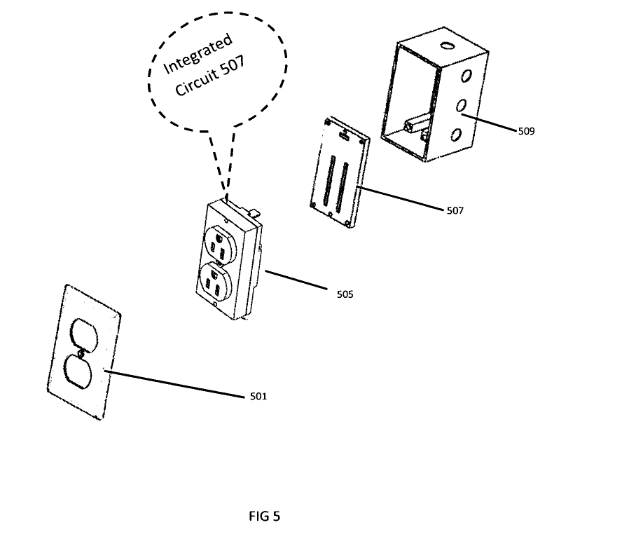

FIG. 4 is an aspect of the system of the present invention.

FIG. 5 is an aspect of the system of the present invention.

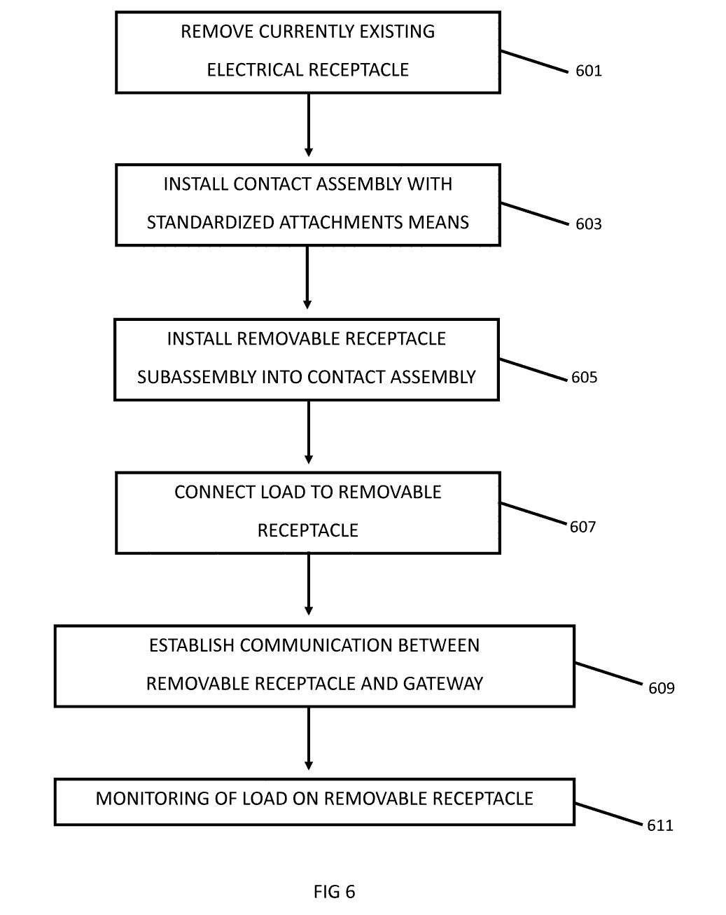

FIG. 6 is an embodiment of the method of the present invention.

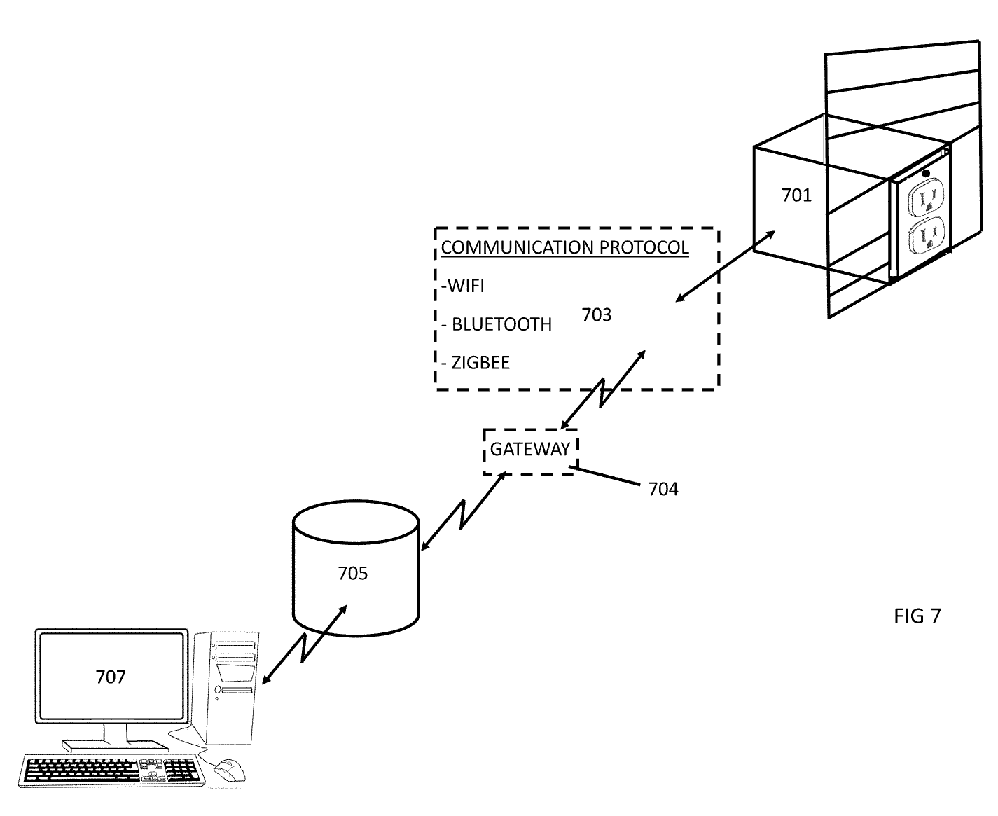

FIG. 7 is a structural layout of the system of the present invention.

FIG. 1 is an example of a receptacle presently used in many older homes and offices (prior art). As shown, the receptacles 100 are comprised of contact openings 101 for engaging with plugs of electrically-driven devices. Wires 105, which connect the receptacle 100 to the main electrical source, are attached to the receptacle 100 via terminal screws 107. The body of the receptacle 100 fits into a “gang” box (not shown) and is attached thereto by its screws (103 and 109).

At issue with currently technology receptacles is upon their shorting, which can happen because of electrical surges, the receptacle must be fully detached from the wires by unscrewing the terminal screws. Prior to even performing unscrewing the terminal screws, power to the receptacle must be turned off. It is recommended that verification testing be made to ensure the power to the wires is completely turned off, lest electrocution occur. In addition, all electronic devices and appliances will lose their configuration like clock or microwave programming and they all have to be reset if not forgotten. While these steps are relatively easy for professional electricians, for the average homeowner, whom may also be a retiree, receptacle swap-out is a dangerous undertaking. Hiring a professional is further a challenge because a professional electrician will charge at least market rate per receptacle, which is a major expense for homeowners on a budget.

FIG. 2 is an embodiment of the present invention, whereby the system of the invention allows a user to quickly and safely “swap out” a receptacle in favor of a new one. The embodiment as shown in FIG. 2 further allows the user to create a hub environment by simply removing an older receptacle in favor of a receptacle system of the present invention.

By hub environment, the present invention refers to the ability to create, within the environment of a structure, the ability to do network and remotely monitor and control any appliances that is connected to a receptacle system of the present invention. Monitoring and controlling is possible because of the use of an integrated circuit positioned within the receptacle system, as well as one or more sensors used to detect aspects of appliance operation.

The integrated circuit (IC) suitable for use in the receptacle system has an input (receiving path) and a transmission path, wherein the IC is capable of using electrical wiring to both carry data and alternating current (AC) for electrical transmission or electric power distribution. The IC can be used in narrowband applications, broadband in-house mains power wiring for data transmissions, and broadband over power line. Each receptacle contains within it at least one IC capable satisfying the purposes of the receptacle. In another embodiment, the receptacle has two or more IC to allow multi-functional receptacle.

As shown in FIG. 2, the receptacle system of the present invention includes a contact assembly plate 207, a receptacle sub-assembly 205, a cover 203, and a variety of attachment means such as screws 201. The receptacle system 200 works with an existing “gang” box 202 of the residence or office.

Under the method using the receptacle system 200 of the present invention, a previous receptacle 204 is removed disconnected from the mains wires and the contact plate sub-assembly 207 of the receptacle system 200 is connected to the mains wires. The receptacle sub-assembly 205 is then connectable to the contact plate sub-assembly 207. A cover 203 is then positioned over the receptacle sub-assembly 205.

Through the method and receptacle system 200, once the contact plate sub-assembly 207 is attached to the mains wires, the receptacle sub-assembly 205 may be continuously swapped out with other types of receptacle sub-assemblies. This allows a user to upgrade receptacles easily on an as-needed basis.

Further, the introduction of the receptacle system 200 of the present invention allows a user to create a hub environment in the residence or office that did not already possess the necessary wiring, for example CAT 5 wiring. While not being shown in FIG. 2, as will be discussed later, the receptacle system 200 possesses a variety of sensors to allow for monitoring and controlling attached appliances. Example sensors include the measurement of current flow, voltage, room temperature, light sensors, timers, humanity sensors, energy usage, and other types of sensors that allow a user to gauge the state of the appliance, environment, surrounding and etc. The receptacle system 200 further has communication technology allowing the receptacle system 200 to be in communication with the wireless hub, router and gateway. Introducing the receptacle system 200 further creates a means to connect from the mains supply to electrical devices via universal serial bus (USB).

USB suitable for the present system allow a user to plug into a traditional AC wall outlet for charging, which avoids the problem of mismatched adapters. This is done by the USB port on a receptacle. An example USB charge port would generate about 5 V DC current from either a 110V AC or 220V AC power receptacle.

FIG. 3 is an embodiment of an aspect of the receptacle system of the present invention, wherein the contact assembly plate 305, which allows the quick-change of receptacles, connects to the mains wires 303 via connect means on the contact assembly plate 305. Connect means on the contact assembly plate 305 can include screw attachments.

As shown in FIG. 3, a key aspect of the present invention is that it can use the gang boxes 301 already present in the existing structure, such as housing or office. This allows a user to install new technology, including IOT-technology, without having to remove or replace the existing wiring in the structure. This allows for major savings in transforming a structure into a hub structure, allowing it to take advantage of new energy saving technologies as well as additional electrical benefits.

FIG. 4 is an embodiment of the receptacle system of the present invention, whereby following the insertion of the contact assembly plate 402 into the existing gang box 401, the contact insert 403(a,b,c) engage with the receptacle sub-assembly (405 or 407). The contact inserts 403(a,b,c) accept male members extending from the receptacle sub-assembly (not shown). The contact inserts 403 includes a positive insert (a), a negative insert (b), and a neutral insert (c).

The existing gang box 401 generally comprises a housing having a floor, a plurality of sidewalls, and an open end defining an interior volume therein. The housing further includes apertures configured to receive electrical wires therethrough. The contact assembly plate 402 is rectangular in construction. The contact assembly plate includes a first side and a second side, whereby the second side includes a plurality of contact openings adapted to receive electrical wiring thereon.

As shown, the receptacle sub-assembly can be of version of a receptacle accepting plugs 405, or a switch-type 407. Both versions possess male members for both connecting to the contact assembly plate 402 and conducting electricity from the mains electricity. As will be discussed later, the receptacle sub-assembly contains IC technology for performing a variety of functions, such as creating a wireless environment, offering a narrow band network, sensing technology for environment and surrounding, USB charging, as well as other functions known in the industry. Two or more IC's may be used in the receptacle sub-assembly to provide multi-functions.

FIG. 5 is an embodiment of the various sub-pieces of the receptacle system of the present invention. As shown, an existing gang box 509 (having main wires contained therein (not shown)), which will have physically connected thereto a contact assembly plate 507, a receptacle sub-assembly 505 that is removably connectable to the contact assembly plate 507, and a cover 501 that is removably attachable to the receptacle sub-assembly 505. Within the receptacle sub-assembly 505 is included an integrated circuit 507, which allows the receptacle sub-assembly to provide one or more functions.

Whereas FIG. 5 shows a plug assembly, various other types of receptacles may be use.

FIG. 6 is an embodiment of the method of present invention for the rapid change of a residence or office into a wireless hub environment.

The steps include removing an existing receptacle from an existing gang box 601. This step generally involves disconnecting mains wires from the existing receptacle (not shown). Because of the benefits and improvements of the present invention, this step generally only needs to occur once.

Following, the contact assembly plate is attached to the mains wires 603 (from which the previous existing receptacle was disconnected from). The contact assembly plate may be attached in a variety of means, including but not limited to side wire, push-in back wire, or screw attachment means. The contact assembly plate is positioned inside the existing receptacle.

The receptacle sub-assembly is then removably attached to the contact assembly plate 605. A load, such as an appliance, for example a heater, coffee maker, iron, etc., is then attached to the receptacle sub-assembly 607.

As an example of the present receptacle system, a wireless communication link can be then established between the receptacle system, and router and gateway 609, the gateway being a node for conducting the transmission of data between the receptacle system and the router. In one example, the data to be transmitted includes a signal “turning off” or “turning on” power to the receptacle, whereby such a signal allows a load connected to the receptacle to be “turned on” or “turned off”.

FIG. 7 is an embodiment of the receptacle system including communication means of the present invention, wherein the receptacle system 701 is positioned in the existing gang box of a wall of the residence or office. An Integrated circuit is included therein, providing a communication protocol system 703 (but for the purposes of FIG. 7, the communication protocol system is shown outside the receptacle system).

The communication protocol system 703 can be protocol based on Zigbee™, Insteon™, Zwave™, WIFI™, BlueTooth™, Thread™, Apple HomeFront™, and other type protocols.

The communication protocol system 703 of the receptacle system connects the receptacle system to a router 704, whereby a gateway as used in the present invention is a node, allowing data and signals to be sent back and forth from the receptacle system to monitoring and controlling devices. In another embodiment, the gateway 704 is router.

The router 704 in general connects to a remote server environment 705, otherwise known as cloud computing. Such a remote server environment 705 allows the storing and accessing of data and programs over a computing network, such as the Internet. The use of such a remote server 705 allows monitor and control of the receptacle system to be performed at a distance away from receptacle system. Example of remote server 705 includes software-as-a-service, platform-as-a-service, and infrastructure-as-a-service.

The remote server 705 allows control of the receptacle system by a client 707, such as a computer system, telephone system, mobile system, tablet devices, mobile systems, and servers.

I claim:

1. A system for converting an existing structure into a wireless hub for remotely monitoring and controlling one or more electrically driven devices, comprising
a pre-existing gang box, wherein mains wires are contained within said gang box and electrically connected to an electrical supply;
a contact assembly plate inserted within said pre-existing gang box and electrically connected to said mains wires;
a removable sub-assembly electrically connected to said contact assembly plate, wherein said removable sub-assembly has a front side and a back side;
a cover positioned over the front of said removable sub-assembly;
an integrated circuit within said removable sub-assembly for providing
wireless connectivity; and
an adapter suitable for allowing wireless communication protocols to the gateway or router.

2. The system for converting an existing structure into a wireless hub for remotely monitoring and controlling one or more electrically driven devices of claim 1, further comprising client system wirelessly connected with a router through a networking environment.

3. The system for converting an existing structure into a wireless hub for remotely monitoring and controlling one or more electrically driven devices of claim 1, further comprising connecting a client capable of connecting to internet for monitoring and controlling the electrically connected device.

4. The system for converting an existing structure into a wireless hub for remotely monitoring and controlling one or more electrically driven devices of claim 1, further comprising of integrated circuits of specialized sensors for monitoring and controlling the electrical activity of one or more electrically driven devices or the environment and surrounding.

5. The system for converting an existing structure into a wireless hub for remotely monitoring and controlling one or more electrically driven devices of claim 1, wherein said removable sub-assembly is a receptacle having a positive, negative, and neutral insert for a ground-fault circuit interrupter (GFCI).

6. The system for converting an existing structure into a wireless hub for remotely monitoring and controlling one or more electrically driven devices of claim 1, further comprising of integrated circuits for a universal serial bus for powering and charging USB devices.

7. The system for converting an existing structure into a wireless hub for remotely monitoring and controlling one or more electrically driven devices of claim 1, wherein said Integrated Circuit further provides the functionality for two or more of a combination of narrowband, universal serial bus, wireless hub, and sensor monitoring.

8. A system for converting an existing structure into a narrowband for remotely monitoring and controlling one or more electrically driven devices, comprising
a pre-existing gang box, wherein mains wires are contained within said gang box and electrically connected to an electrical supply;
a contact assembly plate inserted within said pre-existing gang box and electrically connected to said mains wires;
a removable sub-assembly electrically connected to said contact assembly plate, wherein said removable sub-assembly has a front side and a back side;
a cover positioned over the front of said removable sub-assembly;
an integrated circuit within said removable sub-assembly for providing narrowband.

9. The system for converting an existing structure into a narrowband for remotely monitoring and controlling one or more electrically driven devices in claim 8, further comprising wireless hub for remotely monitoring and controlling one or more electrically driven devices.

10. The system for converting an existing structure into a narrowband for remotely monitoring and controlling one or more electrically driven devices in claim 8, further comprising said removable sub-assembly is a receptacle having a positive, negative, and neutral insert for A ground-fault circuit interrupter (GFCI).

11. The system for converting an existing structure into a narrowband for remotely monitoring and controlling one or more electrically driven devices in claim 8, further comprising of integrated circuits of specialized sensors for monitoring and controlling the electrical activity of one or more electrically driven devices or the environment and surrounding.

12. The system for converting an existing structure into a narrowband for remotely monitoring and controlling one or more electrically driven devices in claim 8, wherein said Integrated Circuit further provides the functionality for two or more of a combination of universal serial bus, wireless hub, and sensor monitoring.

13. The system for converting an existing structure into a narrowband for remotely monitoring and controlling one or more electrically driven devices in claim 8, wherein further comprising of integrated circuits for a universal serial bus for powering and charging USB devices.

14. A method for transforming an existing structure into a wireless hub for remotely monitoring and controlling one or more electrically driven devices, comprising the steps of:
removing an existing electrical receptacle from an existing gang box;
attaching a contact assembly plate to the mains wires of said existing gang box;
positioning said contact assembly plate within said existing gang box;
attaching a removable sub-assembly to said contact assembly plate;
positioning a cover over the front of said removable sub-assembly;
connecting an electrically driven device to said removable sub-assembly;
establishing a connection between an integrated circuit and a router; and
monitoring and controlling said electrically driven device by said client controller.

15. The method for transforming an existing structure into a wireless hub for remotely monitoring and controlling one or more electrically driven devices of claim 14, further comprising connecting a client to the gateway node through a computer networking environment.

16. The method for transforming an existing structure into a wireless hub for remotely monitoring and controlling one or more electrically driven devices of claim 14, whereby attaching a contact assembly plate to the mains wires of said existing gang box comprises attaching by screws means.

17. The method for transforming an existing structure into a wireless hub for remotely monitoring and controlling one or more electrically driven devices of claim 14, further comprising removing said removable specific application sub-assembly and inserting a replacement removable specific application sub-assembly in the original sub-assembly's place.

18. The method for transforming an existing structure into a wireless hub for remotely monitoring and controlling one or more electrically driven devices of claim 14, wherein said replacement removable sub-assembly is selected from the group consisting of a receptacle or a switch.
